(19) United States
(12) Patent Application Publication
(10) Pub. No.: US 2017/0305772 A1
(43) Pub. Date: Oct. 26, 2017

(54) System for Treating Sewage

(71) Applicant: Randall Duval, Colchester, VT (US)

(72) Inventor: Randall Duval, Colchester, VT (US)

(21) Appl. No.: 15/492,449

(22) Filed: Apr. 20, 2017

Related U.S. Application Data
(60) Provisional application No. 62/325,694, filed on Apr. 21, 2016.

(51) Int. Cl. C02F 3/20; C02F 1/32

(52) U.S. Cl. CPC C02F 3/20; C02F 1/325; C02F 2209/42; C02F 2203/006; C02F 2201/322; C02F 2303/04; C02F 2209/40

(57) ABSTRACT

A sewage treatment system uses a multi-stage process to treat waste materials. Sewage is contained in a first tank, from which liquid waste is filtered and transferred to a second tank, where the first tank retains solid waste. The second tank may contain a plurality of chambers, with the chambers connected using ports for fluid communication. Liquid waste in the second tank undergoes aerobic digestion, where an aeration device may aid in the digestion process. The second tank may also include a UV light source to reduce bacteria. The treated liquid from the second tank may be clean enough to be discharged directly into a leach field which would not meet standards for conventional leach fields.

### CROSS-REFERENCE TO RELATED APPLICATION

This application claims the benefit of U.S. Provisional Application No. 62/325,694, filed Apr. 21, 2016

### FEDERALLY-SPONSORED RESEARCH

None

### BACKGROUND

### Field of the Invention, Related Art

The present disclosure relates to that of sewage treatment. More specifically, to septic systems which treat sewage through the separation of liquid waste from solid waste, and in which contaminants and bacteria in the liquid waste are reduced.

A typical conventional septic configuration employs anaerobic digestion of bacteria within the tank, and allows the reduced-bacteria liquid from the tank to drain into a drain or leach field. A tank must be located where soil meets certain standards, such as soil porosity, for the adjoining leach field. Depending on siting constraints, this may require pumping sewage to a location with suitable soil type. Alternately, mound-type systems may be used in locations where soil types are otherwise not suitable as a leach field. Mound systems typically employ two tanks, with the first tank retaining solids, and the second tank metering the amount and timing of liquid waste that exits the system to a soil mound. However, cost and complexity are significant for both mound systems and for systems that require extensive pumping. Further, neither option may be viable in some locations.

### BRIEF SUMMARY OF THE INVENTION

In many sewage systems, solid waste accounts for a much smaller proportion of the total waste stream than do liquids. A two-stage sewage treatment allows solids to first be separated through filtration, with liquid waste then treated separately, preferably in a tank separate from that which retains solid waste. The present system includes treatment methods such as aerobic digestion and exposure to ultraviolet (UV) light sources to then be employed on the liquid waste.

The system described herein provides numerous advantages compared to existing sewage/septic systems, through improved cleaning of the liquid waste portion. Liquid waste is filtered and transferred from a first tank to a second tank, where the first tank retains solid waste. Liquid waste in the second tank, or aeration tank, is treated by aerobic digestion and UV exposure, such that the discharge liquid from the aeration tank may contain only very small amounts of bacteria. The treated liquid may be clean enough to be discharged directly into a leach field which would not meet standards (such as percolation tests) for conventional leach fields.

In an embodiment of the device for treating sewage, there may be: a primary solids tank with a link port, in fluid communication with an aeration tank; the aeration tank including a discharge port, at least one vertical dividing wall, the wall forming at least two chambers; chamber ports which place the chambers in fluid communication with one another; an aeration pump connected to at least one bubble diffuser, the diffuser positioned at the aeration tank's bottom; a UV lightbath positioned in the aeration tank; and a discharge port through which treated liquid waste exits the aeration tank.

An embodiment of the system may include three dividing walls, forming a first chamber, a second chamber, a third chamber, and a final chamber. An embodiment of the system may include a bubble diffuser at a bottom of at least one of the first, second, or third chamber. An embodiment of the system may use three dividing walls including chamber ports; the chamber ports may be positioned in a staggered configuration to promote optimal liquid flow within each chamber. An embodiment of the system may use a UV lightbath in a final chamber. An embodiment of the system may include a discharge port through which treated liquid waste is pumped by a discharge pump to exit the aeration tank, where the discharge pump and the discharge port may be located in a final chamber; a final chamber may include an alarm that signals if liquid in the final chamber has exceeded an allowable level, a final chamber may include a discharge pump includes a float switch for cycling the pump on and off. An embodiment of the system may be a method executed using the above components.

### BRIEF DESCRIPTION OF THE FIGURES

FIG. 1 is a top plan view of system by itself.

FIG. 2 is a cross-sectional view of the system taken along line 2-2 of FIG. 1 showing it in use.

FIG. 3 is a schematic showing electrical connections in the system.

### DETAILED DESCRIPTION OF THE INVENTION

The present system receives sewage waste, treating the sewage in multiple steps to first separate out solid waste, before then treating liquid waste. Tanks described are typically made from cast concrete in one embodiment; however tanks made of other materials such as metals, plastics, or composites may also be used. One embodiment uses an aeration tank with a rectangular cross section and a volume of 1500 gallons. However, other tank shapes and volumes may also readily be used.

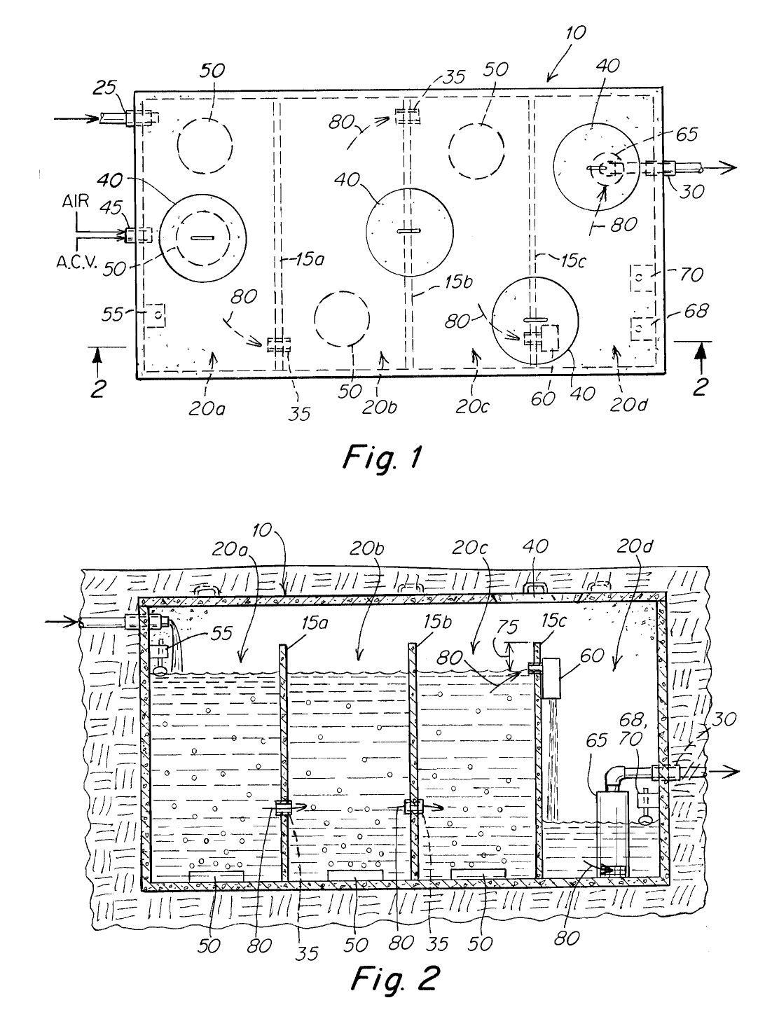

As seen in FIG. 2, waste first enters a primary solids tank (not shown), which includes a link port 25. Link port 25 allows fluid communication between the primary solids tank and an aeration tank 10. The link port 25 is preferably positioned near the top of aeration tank 10. Before liquid travels from the primary tank to aeration tank 10, waste in the primary tank is filtered to remove solids. Such solids filtration is accomplished by filtering devices known in the art.

Aeration tank 10 includes at least one vertical dividing wall; in one embodiment aeration tank 10 includes three vertical dividing walls: first dividing wall 15a, second dividing wall 15b, and third dividing wall 15c. In one embodiment, the dividing walls are made of concrete, cast as part of tank 10; however, other configurations may be used for the wall structures. These three dividing walls separate aeration tank 10 into four chambers: first chamber 20a, second chamber 20b, third chamber 20c, and fourth chamber 20d. The forth chamber may also be called the final chamber. Chamber ports 35 place said chambers in fluid communication with one another. In one embodiment, chamber ports are 1 inch circular openings.

The fourth chamber (or final chamber if the tank contains more or fewer than four chambers) includes discharge pump 65, controlled by pump float switch 70. Discharge port 30 and UV lightbath 60 are also included in the fourth chamber, whose functions will be explained below.

Each of the first three chambers includes a bubble diffuser 50, positioned at aeration tank's bottom. Also in the first chamber 20a is float switch for aeration pump 55. One embodiment includes access ports 40 allowing for service access into aeration tank 10. Port 45 allows for wiring and air tubing needed for components such as the pumps.

By positioning link port 25 near the top of each tank, filtered liquid waste, or effluent, enters chamber one from primary solids tank 5. As seen in FIG. 2, liquid waste may fill the first chamber until reaching the height of chamber port(s) 35. Upon reaching the required height of port 35, liquid may then travel to the second chamber, and in a similar process to the third chamber. FIG. 1 shows the staggered positioning of the chamber ports relative to one another across the different chambers. That is: the chamber port connecting chambers one and two is in a fore position, the chamber port connecting chambers two and three is in an aft position. This staggered chamber port configuration promotes optimal liquid flow within each chamber, insuring that liquid must travel through nearly the entire length of one chamber before entering the subsequent chamber. The liquid waste flow path is further shown by arrows 80. While one embodiment uses this staggered chamber port configuration, other chamber port configurations may also be used.

In one embodiment, each of the first three chambers includes a bubble diffuser 50, positioned at aeration tank's 10 bottom. Each diffuser 50 receives a supply of ambient fresh air from outside the tank from an aeration pump 56, which activated by float switch 55. The aeration pump may be located above-ground, outside of tank 10. Each aerator disperses bubbles in the liquid waste in each chamber, thereby promoting aerobic digestion of bacteria in the waste. Such aerobic digestion processes are known in the art, and will not be explained further here. The aerators serve both to infuse air/oxygen into the liquid, as well as to promote circulation of the waste liquid throughout the first three chambers.

When the level of liquid waste reaches the maximum capacity of the first three chambers, which by definition at equilibrium is the same height in each chamber, the liquid passes from the third chamber to the fourth chamber, also called the final chamber. At this transition, the liquid preferably passes through UV lightbath 60, which further serves to reduce bacteria in the liquid, where the liquid's bacteria has already undergone aerobic digestion in the first three chambers. In FIG. 2, the height of the liquid waste is shown as its maximum level, with the gap 75 shown from the maximum height of the liquid waste to the top of the dividing walls. As the liquid waste reaches its maximum level, it exits from the third chamber 20c to the fourth chamber 20d through a chamber port 35, where the exit of the chamber port includes UV lightbath 60.

In the fourth chamber, liquid accumulates to a height at which pump float switch 70 activates discharge pump 65. Pump 65 then transfers the fully treated liquid waste out of discharge port 30. Once the height of liquid in chamber four drops, float switch 70 deactivates pump 65. In one embodiment, the exit port is a 2 inch circular opening/coupling. Liquid exiting through discharge port 30 may then travel to a leach field, or to other appropriate treatment area. As previously described, the fully treated liquid may be low enough in bacteria to safely allow discharge into a leach field which would normally not meet the criteria for discharge from conventional, mound, or similar septic systems. Optionally, liquid may exit discharge port 30 through the force of gravity, with a discharge pump and its associated components not needed.

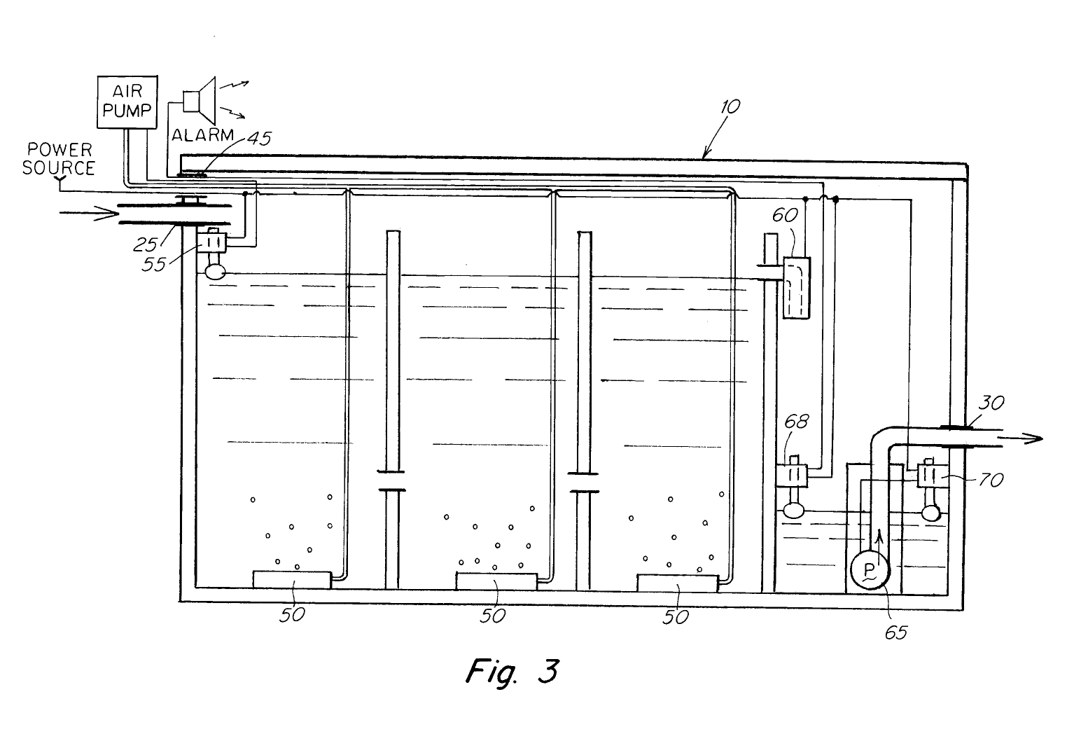

FIG. 3 shows a schematic of the electrical system of the present device. An external power source, such as from the electrical grid, a battery, or an energy-generating device such as a PV panel, supplies power to the system. Aeration pump switch 55, which may be controlled by the level of the liquid in the tank, time, or other factors, triggers the air pump 56 to activate. Air pump 56 then delivers a flow of air through lines to each bubble diffuser 50.

Electrical power is also routed to UV lightbath 60, and optional alarm 68. Alarm 68, if included, triggers an alarm (preferably external to the tank) to alert of a liquid in the fourth chamber than has exceeded an allowable level, caused by a blocked discharge port 30. Any suitable type of alarm may be used, including audible types, visual/light types, or a type that alerts via the internet. Power also is routed to float switch 70 controlling pump 65.

Although the present system has been described with respect to one or more embodiments, it will be understood that other embodiments of the present system may be made without departing from the spirit and scope of the present system. Hence, the present system is deemed limited only by claims and the reasonable interpretation thereof.

What is claimed:

1. A device for treating sewage, comprising:
a primary solids tank with a link port, in fluid communication with an aeration tank;
the aeration tank including a discharge port, at least one vertical dividing wall, the wall forming at least two chambers;
chamber ports which place the chambers in fluid communication with one another;
an aeration pump connected to at least one bubble diffuser, the diffuser positioned at the aeration tank's bottom;
a UV lightbath positioned in the aeration tank; and
a discharge port through which treated liquid waste exits the aeration tank.

2. The device of claim 1, which includes three dividing walls, forming a first chamber, a second chamber, a third chamber, and a final chamber.

3. The device of claim 2, in which a bubble diffuser is included at a bottom of at least one of the first, second, or third chamber.

4. The device of claim 2, in which each of the three dividing walls includes a chamber port.

5. The device of claim 4, in which the chamber ports are positioned in a staggered configuration to promote optimal liquid flow within each chamber.

6. The device of claim 1, in which the UV lightbath is located in a final chamber.

7. A device for treating sewage, comprising:
a primary solids tank with a link port, in fluid communication with an aeration tank;
the aeration tank including a discharge port, at least one vertical dividing wall, the wall forming at least two chambers;
chamber ports which place the chambers in fluid communication with one another;
an aeration pump connected to at least one bubble diffuser, the diffuser positioned at the aeration tank's bottom;
a UV lightbath positioned in the aeration tank; and
a discharge port through which treated liquid waste is pumped by a discharge pump to exit the aeration tank.

8. The device of claim 7, in which the discharge pump and the discharge port are located in a final chamber.

9. The device of claim 7, in which a final chamber includes an alarm that signals if liquid in the final chamber has exceeded an allowable level.

10. The device of claim 1, in which a discharge pump includes a float switch for cycling the pump on and off.

11. The device of claim 7, which includes three dividing walls, forming a first chamber, a second chamber, a third chamber, and a final chamber.

12. The device of claim 11, in which a bubble diffuser is included at bottom of at least one of the first, second, or third chamber.

13. The device of claim 11, in which each of the three dividing walls includes a chamber port.

14. The device of claim 13, in which the chamber ports are positioned in a staggered configuration to promote optimal liquid flow within each chamber.

15. The device of claim 7, in which the UV lightbath is located in a final chamber.

16. A method for treating sewage, comprising:
placing a primary solids tank with a link port in fluid communication with an aeration tank;
using an aeration tank with the link port, a discharge port, at least one vertical dividing wall, the wall forming at least two chambers;
placing the chambers in fluid communication with one another via chamber ports;
diffusing air thru the aeration tank with an aeration pump connected to at least one bubble diffuser, the diffuser positioned at the aeration tank's bottom;
treating said aeration tank's contents with a UV lightbath positioned in the aeration tank; and
pumping out the aeration tank's contents with a discharge pump which includes a float switch, the pump capable of pumping liquid waste out of the discharge port.
